(19) United States
(12) Patent Application Publication
(10) Pub. No.: US 2002/0069925 A1
(43) Pub. Date: Jun. 13, 2002

(54) Elbow protection cover and a method for producing it

(76) Inventor: Takayuki Sawada, Tokyo (JP)

Correspondence Address: OLIFF & BERRIDGE, PLC, P.O. BOX 19928, ALEXANDRIA, VA, 22320, US

(21) Appl. No.: 10/000,960

(22) Filed: Dec. 4, 2001

(30) Foreign Application Priority Data
Dec. 13, 2000 (JP) 2000-378602

(51) Int. Cl. F16L 9/14

(52) U.S. Cl. 138/149; 138/151; 138/153; 138/156; 138/171

(57) ABSTRACT

There is disclosed an elbow protection cover constituting a bending portion of the protection cover covering insulating material used for insulation of pipes with heat insulating material, wherein the whole curved surface of the above-mentioned cover is integrally fabricated by press drawing of a thin metal plate. There can be provided a high quality elbow protection cover wherein cost performance is good, and high strength and prevention of water leak or the like can be achieved by introducing a mass-production method of elbow protection covers instead of manual operation where board members are joined by soldering or the like.

### BACKGROUND OF INVENTION

1. Field of the Invention

The present invention relates to an elbow protection cover constituting a bended portion of a protection cover which is used to cover a heat insulating material when insulating, for example, a fluid pipe with the heat insulating material.

2. Description of the Related Art

Conventionally, pipes in which fluids, such as a gas or a liquid with high temperature or low temperature flow, or a duct for air-conditioning or the like are covered with heat insulating materials such as a heat insulator and a cold insulator for keeping warm or cool. Usually, these heat insulating materials are applied by twisting the plate material or mat material made of diatomaceous earth, rock wool, glass wool, ceramic wool, styrene foam, urethane foam or the like which is porous and contains a lot of air, around a pipe or a duct, adhering them thereon, or putting a pipe cover fabricated tubular (it is also called a heat insulating mould) on pipes.

However, since mechanical strength of these heat insulating materials is usually weak, they are apt to be deformed or damaged by external pressure, impact or the like. Moreover, some materials are liable to generate dust, and heat insulation performance is lowered in some materials due to influence of environment, for example, when it gets wet by rain. Accordingly, they are usually protected by being covered with thin metal plates such as a tin plate and a galvanized steel plate, in order to prevent such damage and to keep appearance.

These covering materials have no problem as for onsite application, when a pipe or a duct is a straight pipe. However, when an elbow which is a bended portion is to be covered, an elbow protection cover cannot be manufactured easily, since a curved surface cannot be formed easily in on-site application, and therefore the elbow protection cover is manufactured beforehand at the factory in many cases. For example, in the case of the right-angled elbow as shown in FIG. 4, first rectangle or spindle-formed board members 21, 22, 23, 24, and 25 are prepared by punching them from a thin iron plate or the like, as shown in FIG. 5. Then, these members are subjected to bending working and put together so that an elbow curved surface may be formed, and at the same time the convex-like rib 4 is formed on the edge of the above-mentioned board members. Then, the edge of each of the board members and the edge with a rib are overlapped each other, and jointing them outside of the curved surface by soldering to make an elbow curved surface. Then, a band board member 26 is welded to both ends by a spot welding, and finally painted. Thereby, the elbow protection cover 1 shown in FIGS. 4(a) and (b) is produced.

The manufacturing method has a problem at present that it takes time to carry out joint and assembling since there are many kinds of members, that it is not suitable for mass production method, since almost all of processes, especially soldering, are carried out by manual operation, that the number of steps are many, and that cost for manufacture is high. Moreover, joint strength is weak since it is conducted by soldering, and thus it will be easy to be separated if external force is applied. Furthermore, they are liable to leak water, and thus rainwater invade easily from outside at a part having a damage.

### SUMMARY OF THE INVENTION

The present invention has been accomplished to solve the above-mentioned previous problems. An object of the present invention is to a high quality elbow protection cover wherein cost performance is good, and high strength and prevention of water leak or the like can be achieved by introducing a mass-production method of elbow protection covers instead of manual operation where board members are joined by soldering or the like.

An elbow protection cover of the present invention is an elbow protection cover constituting a bending portion of the protection cover covering insulating material used for insulation of pipes with heat insulating material, wherein the whole curved surface of the above-mentioned cover is integrally fabricated by press drawing of a thin metal plate.

As described above, the elbow protection cover of the present invention is the elbow protection cover wherein the whole curved surface is integrally fabricated by press drawing of a thin metal plate, and it does not consist of two or more board members and is not manufactured by conventional soldering, conventional spot welding or the like. Since it can be produced by press molding from a piece of a plate, it can be produced by mass-production, and a significant cost reduction can be attained. Moreover, since it is integrally fabricated of a single board member, and it is high quality elbow protection cover wherein strength is high, water leak is hardly caused.

In the present invention, it is preferable that a convex-like ribs are formed on the curved surface of the elbow protection cover.

As described above, if a convex-like rib is formed on the curved surface of the elbow protection cover, the strength of an elbow curved surface can be reinforced and destruction and damage by external force, the impact, or the like can be prevented.

Furthermore, a thin metal plate can be one chosen from the group consisting of a zinc plated steel plate, a cold rolled steel plate, a stainless steel board, an aluminum plate, and an aluminum alloy board.

If such a kind of the thin metal plate is adequately selected depending on the purpose of the covering and environment, a more useful elbow protection cover can be obtained, and production is also easy.

A method for producing an elbow protection cover of the present invention is a method for producing an elbow protection cover constituting a bending portion of the protection cover covering insulating material used for insulation of pipes with heat insulating material, wherein a board member is punched from a thin metal plate in a shape which copies a developed shape of the above-mentioned cover but is bigger than it, the punched board is then worked by a press drawing, so that a cover curved surface is formed, then an unnecessary part is removed, subsequently a bending working of the band section and a process for forming a convex-like rib on a curved surface are simultaneously carried out with a press, and then a convex-like rib is formed on each of the curved surfaces on both sides by a press.

Such a method is a mechanical production method wherein soldering by manual operation or the like is not conducted, but press processing is mainly conducted, productivity can be improved and a significant cost reduction can be achieved. Moreover, since it is integrally fabricated from a single board member, a high quality elbow protection cover wherein strength is high, water leak is never caused can be produced.

As explained in detail above, since the elbow protection cover of the present invention is integrally fabricated by press drawing, differently from the conventional one which is produced by joining more than one thin metal board members by soldering, a spot welding or the like, it has high strength, water leak is hardly caused therein, it can be produced by mass-production, and a significant cost reduction can be attained, and is very useful on industry.

### BRIEF DESCRIPTION OF THE DRAWINGS

FIG. 1 is a schematic view showing an example of the elbow protection cover of the present invention. (a) a front view, the (b) a side view

FIGS. 2(a)-(d) are explanatory views showing a part of a method for producing an elbow protection cover.

FIG. 3 is a flow diagram showing an example of the method for producing an elbow protection cover of the present invention.

FIG. 4 is a schematic view showing an example of an elbow protection cover produced by a conventional process. (a) A front view, the (b) side view

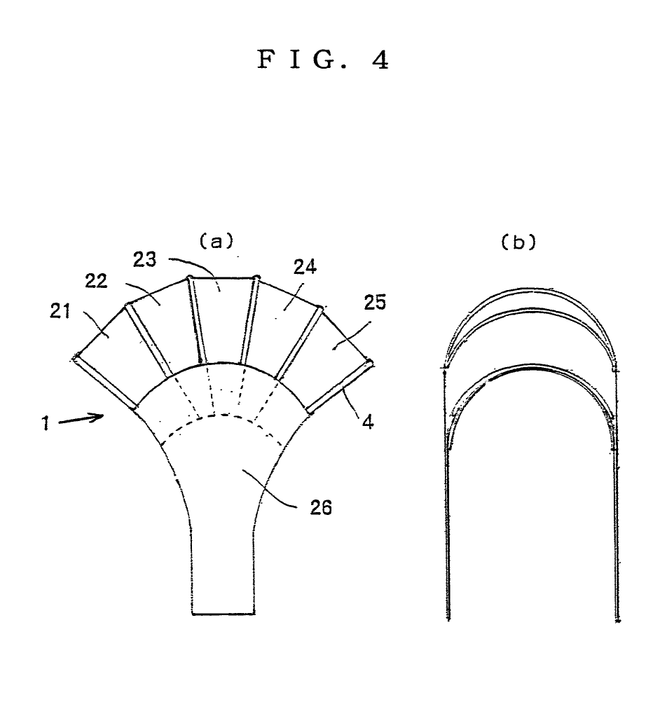

FIG. 5 in an explanatory view showing an example of blank layout of a board member in a conventional manufacturing method.

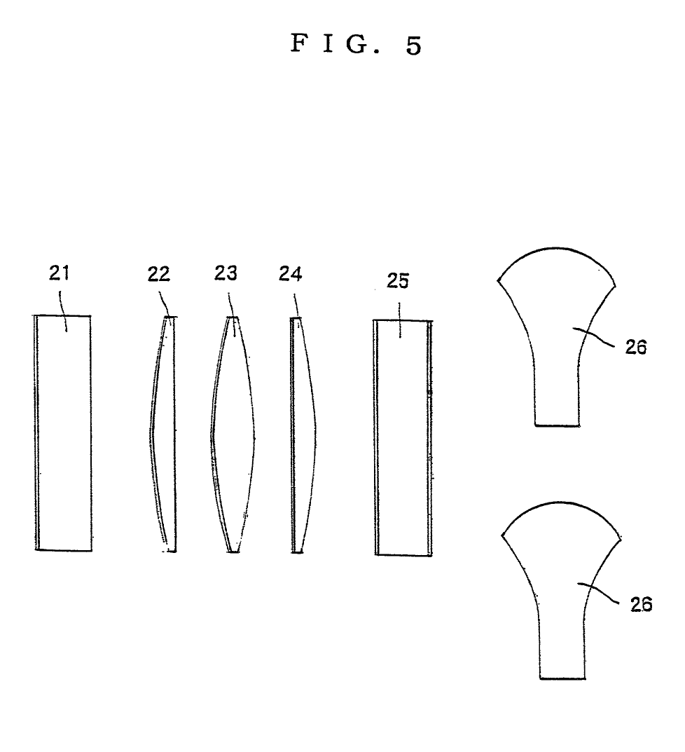

### DESCRIPTION OF THE INVENTION AND EMBODIMENT

The inventors have studied a mechanical mass production method without conducting soldering by the manual operation in manufacture of an elbow protection cover, and thought out that productivity can be improved and cost reduction can be achieved by conducting press drawing of a thin metal plate to fabricate it integrally. Then, they have studied conditions thereof further, and thus completed the present invention.

Hereafter, the present invention will be explained in detail referring to drawings.

The present invention relates to an elbow protection cover constituting a bending portion of the protection cover covering insulating material used for insulation of pipes with heat insulating material, wherein the whole curved surface of the above-mentioned cover is integrally fabricated by press drawing of a thin metal plate.

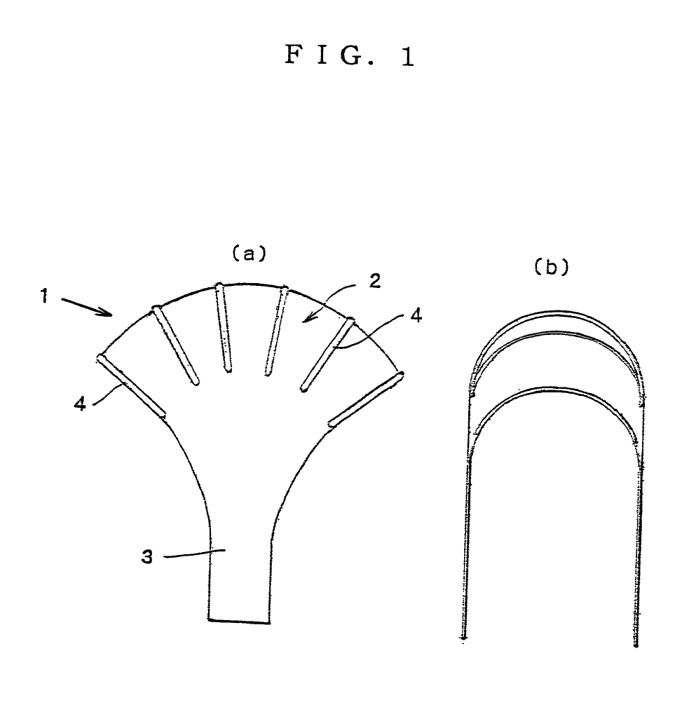

FIG. 1 is a schematic view of an example of the elbow protection cover of the present invention, which is a right angle (90 degrees) elbow protection cover. The 90 degree elbow protection cover 1 consists of an elbow curved surface 2 on which more than one ribs 4 in the shape of a convex are formed and band sections 3 on both ends of the curved surface, and is integrally fabricated from one sheet of thin metal plate.

As described above, since the elbow protection cover of the present invention is integrally fabricated, it has enough strength. Furthermore, it is never separated to each of members, and leakage is not caused, differently from the conventional one produced by soldering.

Application of the 90 degrees elbow protection cover is conducted as follows. If the bands 3, 3 are joined with solder, a spot welding, adhesives or the like at the inside of an elbow portion after putting the elbow protection cover in from the direction of the convex section of the elbow portion of a pipe covered with heat insulating material with the bands 3,3 opened and sticking the cover inside to the heat insulating material, the cover can be easily applied as a cover for the elbow portion of a pipe and a heat insulating material covering the pipe. Moreover, when each the straight pipes on the both sides of the elbow pipe is covered with a heat insulating material and the straight pipe protection cover, it is preferable to join the ends of the elbow protection cover and the ends of the straight pipe protection covers.

The method for producing an elbow protection cover of the present invention will be explained below.

Processes explained here, such as plate punching by a press, press drawing, ribbing and the like can be conducted according to a general press method, and a general press machine and a general metal mold can be used.

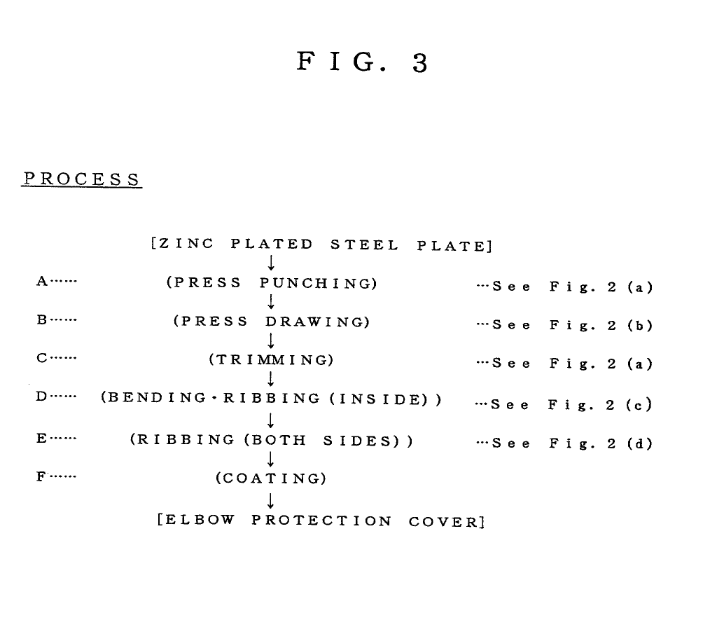

The manufacturing process was shown in FIG. 3 as for a 90 degree elbow protection cover as an example.

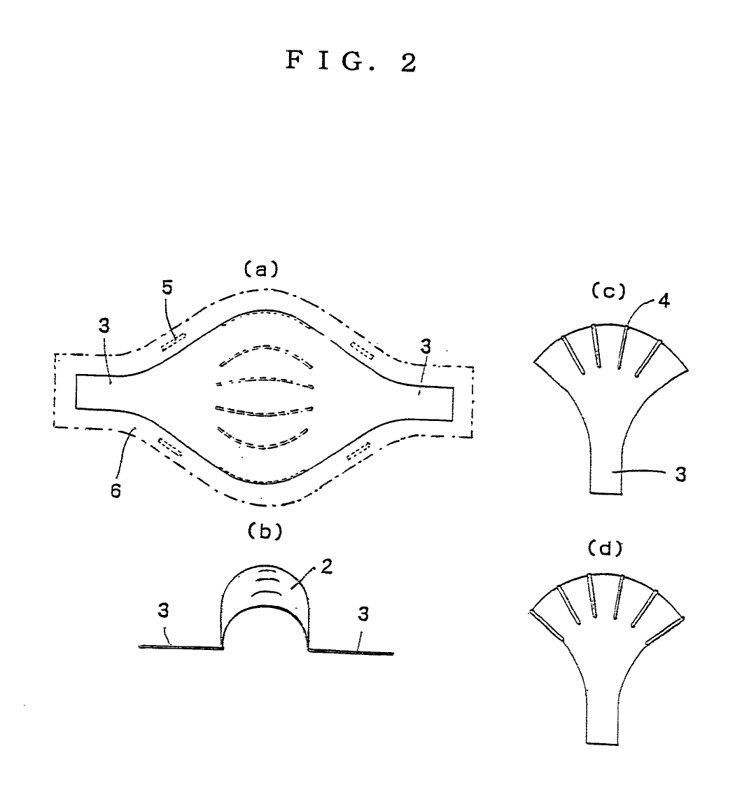

First, in the process A, a thin metal plate, for example, a zinc plating steel plate with a thickness of 0.3 mm is punched in a size not corresponding to the developed shape of the 90 degree elbow protection cover which is to be produced (solid line of FIG. 2(a)), but anticipating a shift due to press drawing or the like (alternate long and short dash line of FIG. 2(a)).

Subsequently, in the process B, the curved surface of the cover is formed by carrying out press forming using a metal mold to which the strings (beads) 5 are attached to at least four places shown in the developed view of the above-mentioned cover (FIG. 2(a)). The beads are for preventing the plate from shifting to a die during press drawing, and is, for example, a string-like member with a width of 3 mm, a height of 2-3 mm and a length of 40-50 mm. The side view of the cover after the press forming is shown in FIG. 2(b). A drawing rate is set to be about 50-70%. The final drawing rate can be achieved either by one draw or by 2 or 3 steps draw. In the latter case, the board material is not loaded excessively, and the manufacture yield is increased.

Next, in the process C, an unnecessary part 6 remaining around the board material wherein the elbow curved surface has already been formed by the press drawing is cut to be removed. This step is called “Trimming”.

Furthermore, in the process D, bending and forming inside ribs are performed. Bending is a step of bending the band sections 3 which was in a horizontal state in press drawing, to have the final shape, that is in a perpendicular state. At the same time, more than one convex-like inside ribs 4 are formed in a curved surface 2.

Next, in the process E, the ribs 4 are formed on both sides of the curved surface 2 by a press. Finally in the process F, the whole surface including the front surface and the back surface of the cover is painted and finished.

As described above, it is preferable to form convex-like ribs on the curved surface of the elbow protection cover.

By forming the convex-like ribs on the curved surface of the elbow protection cover as above, strength of the curved surface can be reinforced and damage due to external force, impact or the like can be prevented.

Furthermore, material for an elbow protection cover can be a thin metal plate selected from a zinc plated steel plate, a cold rolled steel plate, a stainless steel board, an aluminum plate and an aluminum alloy board, depending on the purpose of the coating, environment, or the like.

If such a kind of the thin metal plate is chosen, processing is also easy and the purpose as an elbow protection cover can fully be achieved.

The present invention is not limited to the above-described embodiment. The above-described embodiment is a mere example, and those having substantially the same structure as that described in the appended claims and providing the similar action and effects are all included in the scope of the present invention.

For example, although the 90 degree elbow protection cover was illustrated above, the elbow protection cover may have an obtuse angle or an acute angle from 90 degrees. The material is also arbitrary depending on the purpose.

Moreover, the number of the ribs formed on the curved surface may be appropriately increased or decreased depending on a shape of the curved surface, a size or the like of the cover. Furthermore, although the ribs are formed so that all may be perpendicular to the curved surface in the embodiment shown in FIG. 1(a), they may be formed so that each of ribs may become parallel, and a formation of ribs to be formed is also arbitrary.

What is claimed is:

1. An elbow protection cover constituting a bending portion of the protection cover covering insulating material used for insulation of pipes with heat insulating material, wherein the whole curved surface of the above-mentioned cover is integrally fabricated by press drawing of a thin metal plate.

2. The elbow protection cover according to claim 1 wherein convex-like ribs are formed on the curved surface of the elbow protection cover.

3. The elbow protection cover according to claim 1 wherein the thin metal plate is chosen from the group consisting of a zinc plated steel plate, a cold rolled steel plate, a stainless steel board, an aluminum plate, and an aluminum alloy board.

4. The elbow protection cover according to claim 2 wherein the thin metal plate is chosen from the group consisting of a zinc plated steel plate, a cold rolled steel plate, a stainless steel board, an aluminum plate, and an aluminum alloy board.

5. A method for producing an elbow protection cover constituting a bending portion of the protection cover covering insulating material used for insulation of pipes with heat insulating material, wherein a board member is punched from a thin metal plate in a shape which copies a developed shape of the cover but is bigger than it, the punched board is then worked by a press drawing, so that a cover curved surface is formed, then an unnecessary part is removed, subsequently a bending working of the band section and a process for forming a convex-like rib on a curved surface are simultaneously carried out with a press, and then a convex-like rib is formed on each of the curved surfaces on both sides by a press.
